(19) United States
(12) Patent Application Publication
(10) Pub. No.: US 2009/0228650 A1
(43) Pub. Date: Sep. 10, 2009

(54) RAID system and apparatus for a handheld device

(76) Inventor: Britto Rossario, Bangalore (IN)

Correspondence Address: LSI Corporation c/o Suiter Swantz pc llo, 14301 FNB Parkway, Suite 220, Omaha, NE, 68154, US

(21) Appl. No.: 12/074,792

(22) Filed: Mar. 6, 2008

(51) Int. Cl. G06F 12/00

(52) U.S. Cl. 711/114; 711/E12.001

(57) ABSTRACT

A system comprises a RAID engine disposed within a housing of a handheld computing or communications device and an interface engine connected to the RAID engine for providing an interface between the RAID engine and a memory of the handheld computing or communications device.

### FIELD OF INVENTION

The present disclosure relates generally to RAID technology and more particularly to implementing RAID technology in handheld devices.

### BACKGROUND

A redundant array of independent disks (RAID) is an array of multiple independent hard disk drives that provide high performance and fault tolerance. RAID technology is a storage technology often utilized to improve the processing capability of storage systems. This technology is designed to provide reliability in disk array systems and to take advantage of the performance gains offered by an array of multiple disks over single-disk storage.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Accordingly, an object of this invention is to provide a system for memory backup and storage within a handheld computing or communications device. A system includes, but is not limited to: a RAID engine disposed within a housing of a handheld computing or communications device; and an interface engine connected to the RAID engine for providing an interface between the RAID engine and a memory of the handheld computing or communications device. In addition to the foregoing, other computationally implemented system aspects are described in the claims, drawings, and text forming a part of the present disclosure.

A method includes, but is not limited to: providing a RAID engine disposed within a housing of a handheld computing or communications device; and providing an interface engine connected to the RAID engine for providing an interface between the RAID engine and a memory of the handheld computing or communications device. In addition to the foregoing, other computationally implemented method aspects are described in the claims, drawings, and text forming a part of the present disclosure.

### BRIEF DESCRIPTION OF DRAWINGS

The numerous advantages of the present invention may be better understood by those skilled in the art by reference to the accompanying figures in which:

FIG. 1 is an illustration of a RAID implementation in a handheld according to an exemplary embodiment of the invention;

FIG. 2 is an additional illustration of a RAID implementation in a handheld according to an exemplary embodiment of the invention;

FIG. 3 an additional illustration of a RAID implementation in a handheld according to an exemplary embodiment of the invention;

FIG. 4 illustrates an operational flow representing example operations related to providing a method for turbo compounding according to an embodiment of the invention.

### DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

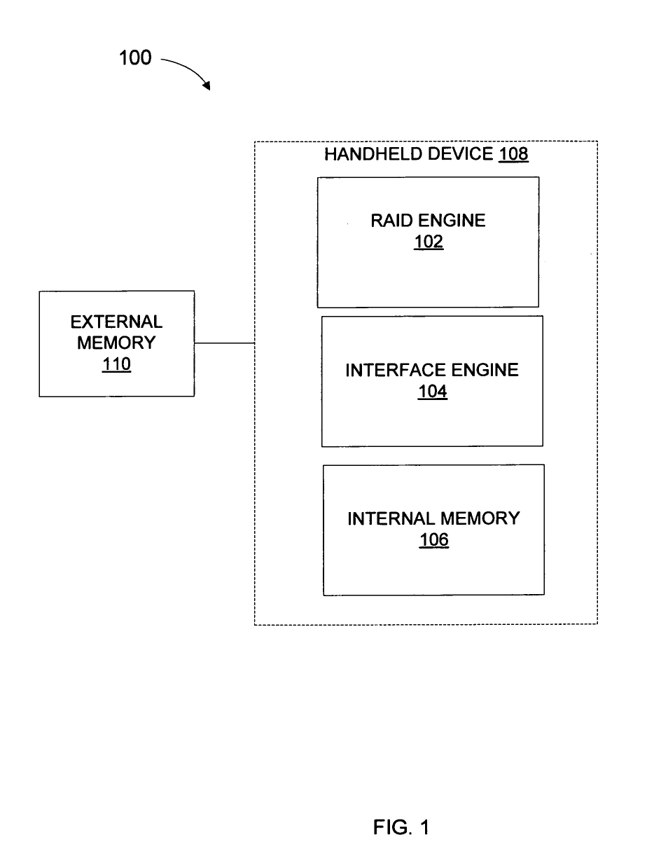

Referring to FIG. 1, a system for providing multiple drives for a handheld computing or communications device is shown. System 100 comprises at least one RAID engine 102 and an interface engine 104 disposed within a protective housing of a handheld communications or computing device 108 (hereinafter “handheld device”). System 100 may further comprise an internal memory 106 and an external memory 110 couplable to the handheld device 108. External memory 110 may be coupled to the handheld device 108 via any known or unknown connection apparatus, including, but not limited to cable, firewire, USB, and/or a wireless connection. System 100 may be implemented in any handheld device 108 including, but not limited to a cellular telephone, such as a voice phone and/or a feature phone, a smart phone, a cordless phone, a Bluetooth headset, a Bluetooth medallion, a handheld game console, a portable media player (PMP), a personal digital assistant (PDA), a personal navigation device (PND) a digital still camera (DSC), a digital video camera (DVC or camcorder), a pager, an eBook Reader, a notebook PC, an ultra-Mobile PC, and/or any combination of these and/or other handheld devices.

Handheld device 108 may include an internal memory 106 including an operating system, personal user data, address book information, calendar information, e-mail information, messages, and messaging capabilities, and an external memory which a user may utilize to manage files. The operating system of the handheld device 108 may be loaded in the internal memory 106 and may provide critical functionality for the handheld device 108 and data availability to a user. The operating system provides usability and accessibility for the handheld device 108, as well as an interface for mobile communication and computing. In some instances, data in an operating system may be corrupted, rendering the mobile device unusable and data on mobile inaccessible.

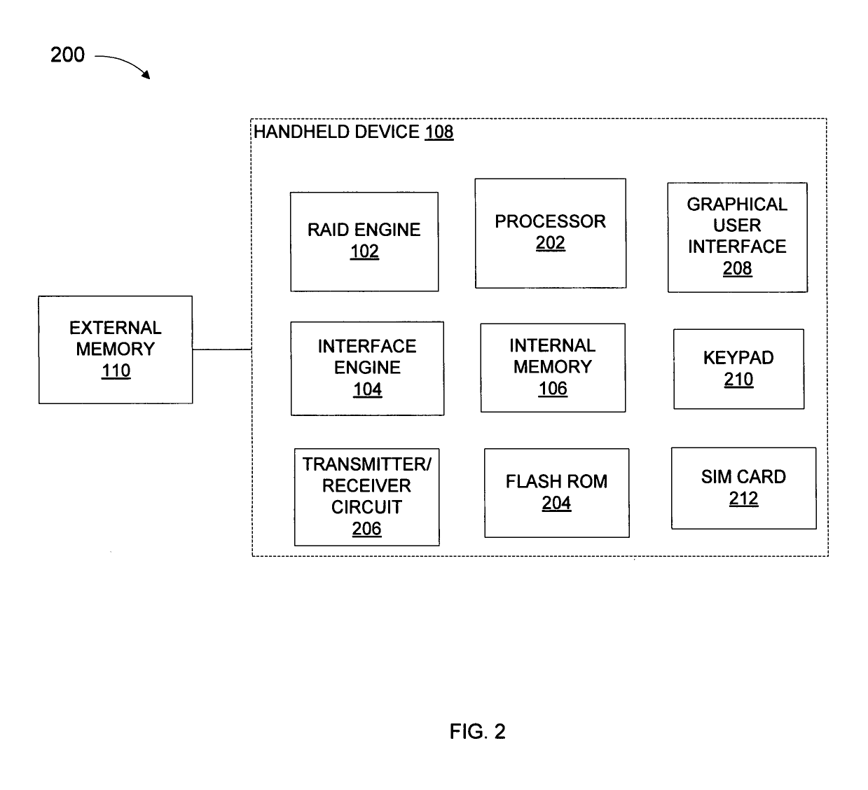

Referring to FIG. 2, an additional illustration of a RAID implementation in a handheld according to an exemplary embodiment of the invention is shown. Handled device 108 may also include a processor 202, a flash ROM 204, a transmitter/receiver circuit 206, a graphical user interface 208, a keypad 210, and a subscriber identity module (SIM) card 212.

RAID engine 102 may provide RAID 1 level functionality for the handheld device 108. RAID 1 also known as “disk mirroring”, which provides data written to one disk drive to be simultaneously written to another disk drive. Thus, if one drive fails, data (and software applications) may be preserved on another drive of the RAID array. RAID engine 102 may replicate all or substantially all the data written on the internal memory 106 to an external memory 110. RAID engine 102 may also include a code executable in the event of a handheld device operating system crash. Executable code may include a recovery option mapped to the internal memory 106 and the external memory 1 10 of the handheld device 108. An operating system boot signature may be written on the bootable memory, and the RAID engine 102 may read the signature. The handheld device 108 may boot upon confirmation of the operating system boot signature.

System 100 may provide multiple drives allowing maintenance of data without system downtime in the even any one drive to fails. In the event of a disk failure, disk access may continue normally and the failure may be transparent to the host system. RAID 1 implements disk mirroring, where a copy of the same data is recorded onto two drives. By keeping two copies of data on separate disks, data is protected against a disk failure. If a disk in the RAID 1 array fails, the remaining good disk (copy) can provide all of the data needed, thus preventing downtime. RAID engine with RAID 1 functionality may also provide improved performance, when multiple concurrent I/O operations are running. System 100 may provide distribution of the operations between disk copies, thus reducing total effective data access time.

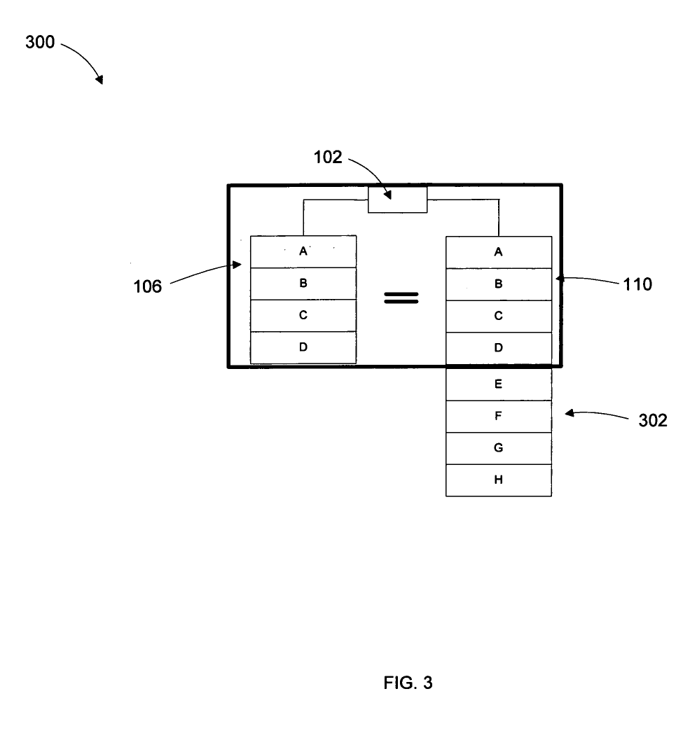

Referring to FIG. 3, an illustration of a RAID implementation in a handheld according to an exemplary embodiment of the invention is shown. Internal memory 106 and external memory 110 may be considered as two independent disks constituting a simple RAID I storage subsystem in a handheld computing or communications device. Internal memory 106 may be the source disk and a part of external memory equal to the internal memory capacity 110 may be the destination disk, where the internal memory data will be mirrored. External memory may also include additional memory capacity 302 not utilized in disk mirroring. In disk mirroring, the total usable capacity is equivalent to the capacity of one drive in the RAID 1 array. Thus, combining two 1-Gbyte drives, for example, creates a single logical drive with a total usable capacity of 1 Gbyte. This combination of drives may appear to the system as a single logical drive.

In the event of an operating system failure, data available on the internal memory 106 of the handheld device 108 may be lost. System RAID engine 102 within the handheld device 108 may retrieve data within a time frame that may be on the order of a few minutes or a few seconds. System 100 may also provide new data written onto the internal memory 106 to be written on the external memory 110. As shown in FIG. 3, external memory capacity may be more than double the internal memory capacity. External memory 110 may also be bootable in crash or failure scenarios. Further, a portion of the external memory 110 may become an exact replica of the internal memory.

A hardware boot sequence of the handheld device 106 may be modified. For example, the boot vector of the handheld device processor may map to the RAID engine 102 and execute the bootable code in the RAID engine 102. The RAID engine 102 may become the primary boot device where information regarding the actual boot device (internal or external memory based on the condition/scenario) requiring mapping is written. Once a RAID pair is created with the internal and external memory, a copy of internal memory may be maintained in the external memory at substantially all times with substantially all the recent data written. In this manner, the external memory also has the boot signature written onto it. When a handheld device is restarted, the recovery option may include the disk listed and may be masked to the user.

If the operating system in the internal memory 106 crashes while booting, the RAID engine 102 may execute an instruction to boot the device 108 from the external memory 110. In case of a corruption of the operating system while the device is operating, the RAID engine may divert all or substantially all of the data requested to the external memory without downtime. Recovery operations for the internal memory 106 may be performed following the device boot. The external memory 110 may be removable for external use, without affecting an active task. The external memory 110 may be reinserted into the handheld device, and the RAID engine may rebuild the data from the internal memory 106. The external memory 110 may be an exact representation of data stored on the internal memory 106.

System 100 RAID engine 102 may be constructed with a form factor configured to fit within a handheld device housing of a handheld device 108. RAID engine 102 may be implemented at the hardware level to provide RAID 1 functionality for the handheld device 108. For instance, RAID engine 102 may be installed within the protective covering of the handheld device 108 and comprise connectivity components necessary to provide storage and backup for handheld device memory components.

System interface engine 104 may be connected to the RAID engine 102 and may be utilized to configure the RAID engine 102 in a handheld device 108. Interface engine 104 may be, for example, a personal computing suite suitable for configuring the RAID1 engine with personal computing connectivity. Interface engine 104 may provide enable and/or disable functions for the system RAID engine 102, and enable a backup facility in the handheld device 108. A backup of the internal memory 106 may be generated when the handheld device is connected to a computing device. Interface engine 104 may also be installed on a personal computing device. The backup may be saved as a compressed image with the date and time stamp as the file name.

The interface engine 104 may provide an additional recovery option other than the RAID engine 102 in case of failure of both the internal memory and external memory operating system crash. An operating system crash may occur if the handheld device 108 is infected by a virus, malware, spyware, and/or any other grayware, etc. Interface engine 104 may provide an option to flash a latest copy or version of backup data into the external memory 110. Interface engine 104 may include an embedded driver to detect memory devices in a computing device that may be connected to the handheld device 108. Once detected, a connection may be established between a computing device and the handheld device 108 via the interface engine 104. Internal and external memory details may appear on a display of the handheld device 108 such as a graphical user interface 208 (GUI). The RAID engine 102 may be configured with the GUI 208 with the available internal and external memory. Interface engine may also comprise an option to create RAID pairs for additional storage or memory capacity. Interface engine 104 may include manual and scheduled backup. Interface engine 104 may include instructions configured to separate a RAID pair, if, for instance, a user desires to utilize external memory 110 only. For instance, a RAID pair may be created with the internal memory 106 and external memory 110 (equal to internal memory capacity). In case of data failure (e.g. an operating system crash), the data from the external memory 110 may be mirrored back to the internal memory 106 from the RAID configured region. In case of virus infection, backup feature may be utilized to restore the image from the last taken snapshot. Interface engine 104 may utilize unconfigured space to store user data.

System 100 implementation within a handheld device 108 may provide recovery with zero or very less downtime for scenarios including, but not limited to: operating system crash, internal memory data corruption, internal memory hardware crash, and/or external memory data corruption. System 100 may provide manual or scheduled backup online mirroring and recovery. System 100 may provide high data availability and 100% redundancy and may maintain data integrity after recovery backup options.

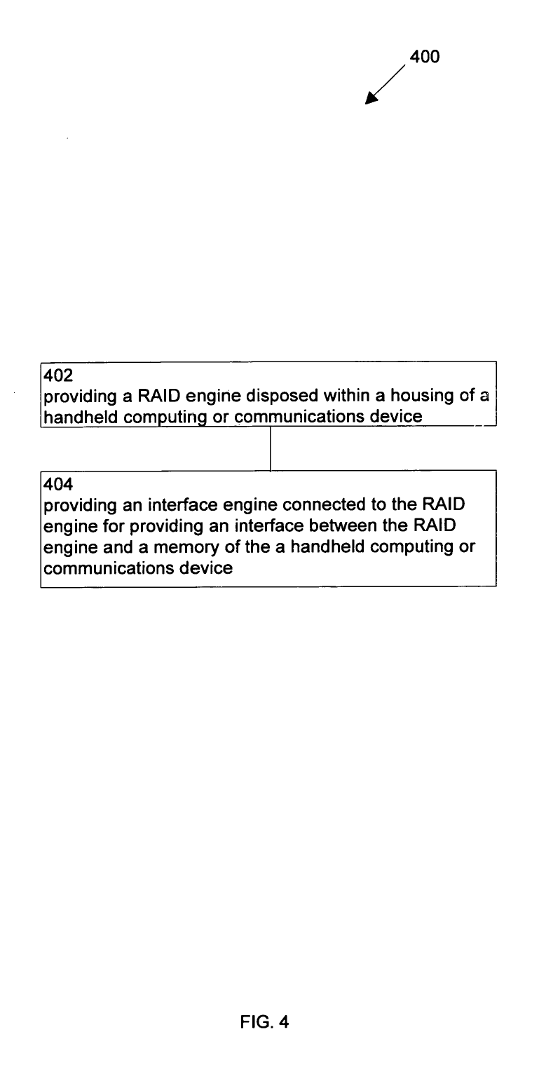

Referring to FIG. 4, an operational flow 400 representing example operations related to providing a method of implementing RAID technology within a handheld device according to an embodiment of the invention is illustrated. In FIG. 4 and in following figures that include various examples of operational flows, discussion and explanation may be provided with respect to the above-described examples of FIGS. 1-3 and/or with respect to other examples and contexts. However, it should be understood that the operational flows may be executed in a number of other environments and contexts, and/or in modified versions of FIGS. 1-3. Also, although the various operational flows are presented in the sequence(s) illustrated, it should be understood that the various operations may be performed in other orders than those which are illustrated, or may be performed concurrently.

Method 400 begins at an operation 402. Operation 402 depicts providing a RAID engine disposed within a housing of a handheld computing or communications device. Operation 404 depicts providing an interface engine connected to the RAID engine for providing an interface between the RAID engine and a memory of the handheld computing or communications device.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A system comprising:
a RAID engine disposed within a housing of a handheld computing or communications device; and
an interface engine connected to the RAID engine for providing an interface between the RAID engine and a memory of the handheld computing or communications device.

2. The system of claim 1, wherein the handheld computing or communications device is at least one of a voice phone, a feature phone, a smart phone, a cordless phone, a Bluetooth headset, a Bluetooth medallion, a handheld game console a portable media player (PMP), a personal digital assistant (PDA), a personal navigation device (PND) a digital still camera (DSC), a digital video camera (DVC or camcorder), a pager, an eBook Reader, a notebook PC, or an ultra-Mobile PC.

3. The system of claim 1, wherein the RAID engine provides RAID 1 level functionality for the handheld device.

4. The system of claim 1, wherein the internal memory includes at least one of an operating system, personal user data, address book information, calendar information, e-mail information, messages, or messaging capabilities.

5. The system of claim 1, further comprising an external memory connectable to the handheld computing or communications device.

6. The system of claim 5, wherein the RAID engine in configured to create at least one RAID pair between the internal memory and external memory.

7. The system of claim 5, wherein the RAID engine replicates all or substantially all the data written on the internal memory to the external memory.

8. The system of claim 5, wherein the RAID engine includes instructions executable in the event of a handheld device operating system crash, the executable instructions including a recovery option mapped to the internal memory and the external memory of the handheld device.

9. The system of claim 1, wherein the internal memory comprises an operating system boot signature readable by the RAID engine.

10. The system of claim 9, wherein the RAID engine reads and confirms the operating system boot signature, and the handheld device boots upon confirmation of the operating system boot signature by the RAID engine.

11. The system of claim 5, wherein the RAID engine executes an instruction to boot the device from the external memory.

12. The system of claim 5, wherein the interface engine is configured to flash a latest copy of backup data into the external memory.

13. The system of claim 5, wherein the interface engine is configured to create RAID pairs for additional storage or memory capacity or separate a RAID pair to provide external memory use.

14. The system of claim 5, wherein the interface engine provides manual and pre-scheduled backup of internal and external memory.

15. The system of claim 1, wherein the interface engine is personal computing suite suitable for configuring the RAID1 engine with personal computing connectivity.

16. The system of claim 1, wherein the interface engine is configured to enable or disable the RAID engine.

17. The system of claim 1, wherein the interface engine includes an embedded driver to detect a memory device in a computing device that may be connected to the handheld device.

18. A method comprising:
providing a RAID engine disposed within a housing of a handheld computing or communications device; and
providing an interface engine connected to the RAID engine for providing an interface between the RAID engine and a memory of the handheld computing or communications device.

19. The method of claim 18, further comprising:
providing an external memory connectable to the handheld computing or communications device.

20. A handheld computing or communications device comprising:
a housing;
a RAID engine disposed within the housing;
an interface engine connected to the RAID engine for providing an interface between the RAID engine and an internal memory of the handheld computing or communications device;
a processor;
a flash ROM;
a transmitter/receiver circuit;
a graphical user interface;
a keypad; and
and a subscriber identity module (SIM) card.
